(19) United States
(12) Patent Application Publication
(10) Pub. No.: US 2021/0050766 A1
(43) Pub. Date: Feb. 18, 2021

(54) OUTER ROTOR MOTOR

(71) Applicant: TECHTRONIC CORDLESS GP, Anderson, SC (US)

(72) Inventors: Hei Man Lee, Hong Kong (CN); Nan Wang, Guangdong (CN)

(21) Appl. No.: 16/964,450

(22) PCT Filed: Feb. 14, 2018
(86) PCT No.: PCT/CN2018/076826

§ 371 Date: Jul. 23, 2020

(51) Int. Cl. H02K 21/22; H02K 1/27; H02K 9/06

(52) U.S. Cl. CPC H02K 21/22; H02K 2201/03; H02K 9/06; H02K 1/2786

(57) ABSTRACT

An outer rotor motor having a stator and a rotor. The rotor includes a bonded magnet arranged around the stator, with an air-gap arranged between the bonded magnet and the stator.

### TECHNICAL FIELD

The invention relates to an outer rotor motor.

### BACKGROUND

An electric motor generally includes a moving part (a rotor) and a stationary part (a stator). The rotor may include multiple permanent magnet pieces and the stator may include multiple windings. Electromagnetic interaction of the permanent magnet pieces with the windings turns the motor shaft to deliver mechanical power.

Despite its long history of development, there remains need to improve on motor designs, to provide motors that can be made compact, operationally efficient, and can be assembled, manufactured, and operated cost-effectively.

### SUMMARY OF THE INVENTION

In a first aspect of the invention, there is provided an outer rotor motor, comprising: a stator; and a rotor including a bonded magnet arranged around the stator, with an air-gap arranged between the bonded magnet and the stator. The bonded magnet may be made of hard magnetic powder and non-magnetic polymer or rubber binder. The hard magnetic powder may be hard ferrite, NdFeB, SmCo, AlNiCo, or combination of two or more of them.

The bonded magnet may be in the form of a hollow cylinder, e.g., in one piece. Preferably, the bonded magnet has circumferentially alternating North and South poles. The number of poles is preferably an even number.

Preferably, the poles are of substantially the same angular extension (i.e., in cross-section, arc length). Alternatively, the poles may have different angular extensions. The magnetization produced by the poles may be a straight magnetization, a skewed magnetization, etc.

Preferably, the rotor further comprises a rotor yoke. The bonded magnet may be mounted around (on an outer surface of) the rotor yoke, in which case the air-gap is arranged between the rotor yoke and the stator. Alternatively, the bonded magnet may be mounted in (on an inner surface of) the rotor yoke, in which case the air-gap is arranged directly between the bonded magnet and the stator. In this case, the air-gap is preferably less than 1.00 mm, more preferably about 0.50 mm. Optionally, the rotor yoke may be omitted.

Preferably, the outer rotor motor further comprises an integrated PCB assembly arranged on one side of the bonded magnet. The integrated PCB assembly may include mounting portions for mounting the outer rotor motor to a support structure. An axial gap may be defined between the bonded magnet and the integrated PCB assembly.

Preferably, the rotor further comprises an end cap with vanes, arranged on another side of the bonded magnet opposite the integrated PCB assembly. The vanes may assist with dissipating heat during operation. The end cap may be fixedly connected with the bonded magnet. The end cap may be directly connected with the bonded magnet, or it may be indirectly connected to the bonded magnet through the rotor yoke.

Preferably, the vanes extend radially and are evenly angularly spaced apart. An air flow opening may be arranged between respective adjacent vanes.

Preferably, the air-gap, the axial gap, and the air flow openings are in fluid communication to define a cooling air flow path.

Preferably, the rotor further comprises a shaft operably coupled with bonded magnet for rotation. Preferably, the shaft extends through the end cap, the bonded magnet, the stator, and the PCB assembly.

Preferably, the outer rotor motor is a brushless motor. More preferably, the outer rotor motor is a DC brushless motor.

In a second aspect of the invention, there is provided a rotor for an outer rotor motor, comprising: a bonded magnet configured to be arranged around a stator and spaced apart from the stator, with an air-gap arranged between the bonded magnet and the stator. The bonded magnet may be made of hard magnetic powder and non-magnetic polymer or rubber binder. The hard magnetic powder may be hard ferrite, NdFeB, SmCo, AlNiCo, or combination of two or more of them.

Preferably, the bonded magnet is in the form of a hollow cylinder, e.g., in one piece. Preferably, the bonded magnet has circumferentially alternating North and South poles. The number of poles is preferably an even number.

Preferably, the poles are of substantially the same angular extension (i.e., in cross-section, arc length). Alternatively, the poles may have different angular extensions. The magnetization produced by the poles may be a straight magnetization, a skewed magnetization, etc.

Preferably, the rotor further comprises a rotor yoke. The bonded magnet may be mounted around (on an outer surface of) the rotor yoke, in which case the air-gap is arranged between the rotor yoke and the stator. Alternatively, the bonded magnet may be mounted in (on an inner surface of) the rotor yoke, in which case the air-gap is arranged directly between the bonded magnet and the stator. In this case, the air-gap is preferably less than 1.00 mm, more preferably about 0.50 mm. Optionally, the rotor yoke may be omitted.

Preferably, the rotor further comprises an end cap with vanes, arranged on one side of the bonded magnet. The vanes may assist with dissipating heat during operation. The end cap may be fixedly connected with the bonded magnet, optionally through the rotor yoke.

Preferably, the vanes extend radially and are evenly angularly spaced apart. An air flow opening may be arranged between respective adjacent vanes.

Preferably, the outer rotor motor is a brushless motor. More preferably, the outer rotor motor is a DC brushless motor.

In a third aspect of the invention, there is provided an outer rotor motor with the rotor of the second aspect.

In a fourth aspect of the invention, there is provided an electric appliance or tool comprising the outer rotor motor of the first aspect.

In a fifth aspect of the invention, there is provided an electric appliance or tool comprising the outer rotor motor of the third aspect.

### BRIEF DESCRIPTION OF THE DRAWINGS

Embodiments of the invention will now be described, by way of example, with reference to the accompanying drawings in which:

FIG. 1 is the perspective view of an outer rotor motor in one embodiment of the invention;

FIG. 2 is an exploded view of the outer rotor motor of FIG. 1;

FIG. 3 is a cross-sectional view of the outer rotor motor in FIG. 1 taken along line A-A;

FIG. 4 is an exploded view of the outer rotor motor cross-section of FIG. 3;

FIG. 5A is a cross-sectional view of the outer rotor motor in FIG. 1 taken along line B-B;

FIG. 5B is a zoomed in view of part C in FIG. 5A;

FIG. 5C is a cross-sectional view of the outer rotor motor of FIG. 5A labeled with dimensions;

FIG. 6 is schematic view of a bonded magnet that is used in the outer rotor motor of FIG. 1 in one embodiment of the invention; and

FIG. 7 is schematic view of a bonded magnet that can be used in the outer rotor motor of FIG. 1 in another embodiment of the invention.

### DETAILED DESCRIPTION OF THE PREFERRED EMBODIMENT

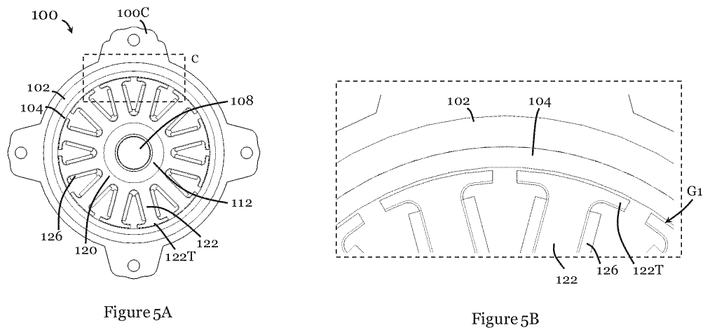

Referring to FIGS. 1 to 4, there is shown an outer rotor motor 100 in one embodiment of the invention. The main components of the motor 100 include an outer rotor 100A, a stator 100B arranged in a space defined by the outer rotor 100A, and an integrated PCB assembly 100C disposed on one side (along the axial direction) of the rotor 100A and stator 100B.

The rotor 100A includes a rotor yoke 102, in the form of a hollow cylinder, arranged around a bonded magnet 104, also in the form of a hollow cylinder. The bonded magnet 104 is made with NdFeB. The rotor yoke 102 is electromagnetically conductive. The bonded magnet 104 is fixedly attached to the inner surface of the rotor yoke 102. The bonded magnet 104 has a smaller axial dimension than the rotor yoke 102. The axial end face of the bonded magnet 104 facing the PCB assembly 100C and the axial end face of the rotor yoke 102 facing the PCB assembly 100C are aligned. An end cap 106 is arranged on one side of the bonded magnet 104 and fixedly connected with the rotor yoke 102. The axial end of the end cap 106 facing the bonded magnet 104 includes cutouts for receiving the bonded magnet 104 such that the end cap 106 and the bonded magnet 104 together define a smooth circumferential outer surface. The end cap 106 includes a cylindrical hub 106H with a central through-opening 106O through which the motor shaft 108 passes, and vanes 106V that extend radially outwardly from the cylindrical hub 106H. The outer radial ends of the vanes 106V terminate at an extent corresponding to the outer circumferential surface of the bonded magnet 104. The vanes 106V are distributed evenly angularly about the hub 106H. Between adjacent vanes 106V is respective openings 106VO that allows air to pass. The bonded magnet 104, the yoke 102, and the end cap 106 together define a space in which the stator 100B can be arranged.

The rotor 100A also includes an elongated, stepped motor shaft 108 mounted in the central through-opening 106O defined by the hub 106H of the end cap 106. An axial end of the shaft 108 is axially aligned with an axial end face of the end cap 106 facing away from the stator 100B. The shaft 108 is generally cylindrical, with three stepped portions of reducing diameter, extending away from the end cap 106, through the stator 100B and the PCB assembly 100C, and then away from the PCB assembly 100C. The stepped portion with the largest diameter of the shaft 108 has an outer annular groove 108G for receiving a C-clip 110 for assembling the motor 100. The stepped portion with the smallest diameter of the shaft 108 has an outer threaded surface 108T. A mounting sleeve 112 with a central through-opening 112O is arranged at an end of the shaft 108 near the end cap 106. The mounting sleeve 112 includes an annular base 112B of larger outer diameter and another annular support 112S of smaller outer diameter integral with the annular base 112B. The part of the through-opening 112O defined by the annular base 112B defines an interior space for receiving a bearing 114 and a wave spring washer 116 for supporting rotation of the shaft 108. The wave spring washer 116 abuts the axial end face of the interior axial wall of the annular support 112S. The annular support 112S is arranged to be received in an opening 124 defined by the stator 100B. The bonded magnet 104, the rotor yoke 102, the end cap 106, and the shaft 108 are arranged coaxially with respect to the rotation axis R, about which the rotor 100A rotates.

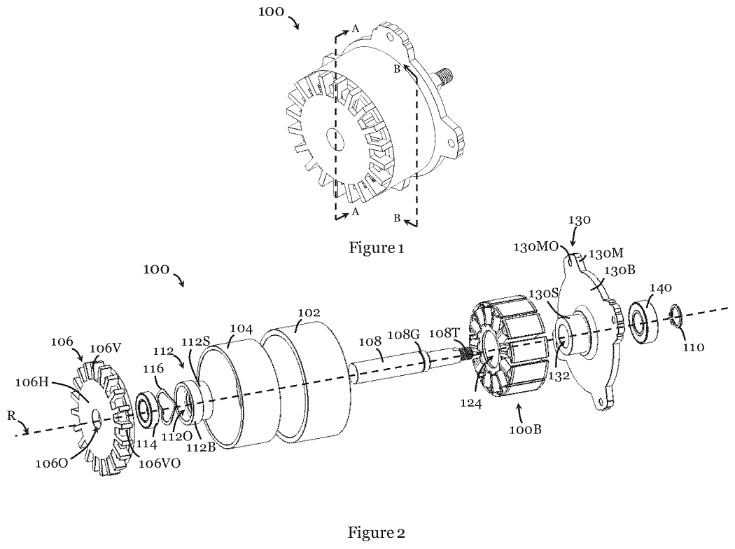

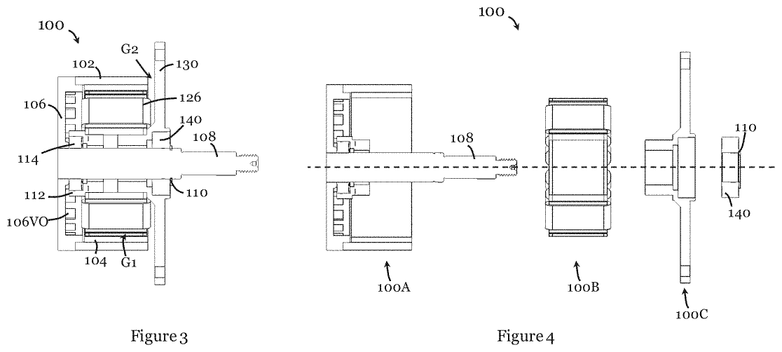

Referring now to FIGS. 2 to 5B, the stator 100B includes an annular stator yoke 120 defining a central through-opening 124 through which the shaft 108, the mounting sleeve 112, and the support part 130S of the PCB assembly 100C can pass. Radially outwardly extending teeth 122 are arranged around the stator yoke 120. In this embodiment, the stator 100B includes twelve teeth 122 that are evenly angularly spaced apart. Slots are defined between adjacent teeth 122. Each tooth 122 defines a tooth tip 122T with a circumferential extension. The outer circumferential surface of the teeth 122 is spaced apart from the rotor yoke 102 by an annular air gap G1. Windings 126 are wounded around the teeth 122. The outer circumferential surface defined by the tips 122T of the teeth 122 is complementary to the inner surface of the rotor yoke 102. For simplicity, the detailed control and excitation scheme of the windings 126 is omitted.

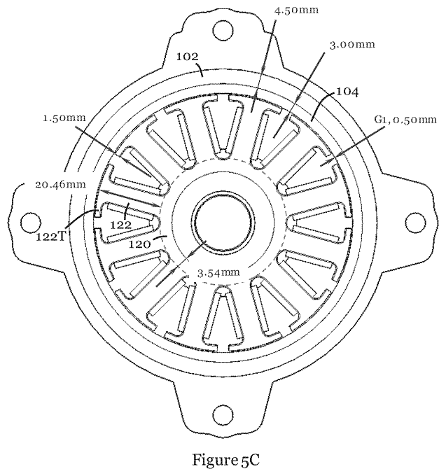

Referring to FIG. 5C, in this example, the bonded magnet 104 has a thickness of about 3.00 mm and an axial length (FIG. 2) of about 30 mm. The thickness of the rotor yoke 102 is about 4.50 mm. The thickness of the stator yoke 120 is about 3.54 mm. The thickness of the tooth 122 is about 20.46 mm, including a tooth tip 122T thickness of about 1.50 mm.

The integrated PCB assembly 100C of the motor 100 is best illustrated in FIGS. 2 to 4. The PCB assembly 100C includes a thin, generally planar body 130B holding circuit and electronic components (for clarity, not shown) mounted thereon. The body 130B includes a generally round contour, with four radially outwardly extending mounting parts 130M, and a central through-opening 132. The axial end face of the body 130B facing the stator 100B and rotor 100A is spaced apart from the stator 100B to define an axial gap G2. The mounting parts 130M each defines an opening 130MO, which may be threaded, for receiving a fastener (not shown) to mount the motor 100 to a support structure such as another casing. An integral annular support sleeve 130S projects from the axial end face of the body 130B, towards the rotor 100A and stator 100B. The annular support sleeve 130S is received in the central through-opening 124 of the stator 100B. The through-opening 132 in the body 100B is arranged to receive a bearing 140 for supporting rotation of the shaft 108. The C-clip 110, when mounted in the groove 108B of the shaft 108, abuts the axial end face of the bearing 140. Referring to FIG. 3, the air-gap G1, the axial gap G2, and the air flow openings 106VO are in fluid communication to define a cooling air flow path.

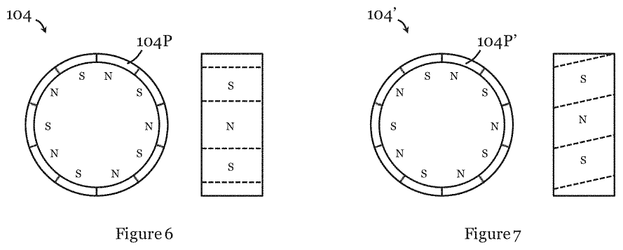

FIG. 6 shows the bonded magnet 104 used in the outer rotor motor 100 of FIG. 1. The bonded magnet 104 has circumferentially alternating North and South poles 104P. In this example, there are 10 poles of generally the same angular extension (e.g., each spans about 36 degrees), extending in parallel to the axial dimension of the magnet 104. The magnetization produced by the poles in this example is a straight magnetization.

FIG. 7 shows another bonded magnet 104′ that can be used in the outer rotor motor 100 of FIG. 1. In this example, the bonded magnet 104′ has circumferentially alternating North and South poles 104P′, but extending obliquely with respect to the axial dimension of the magnet 104′. The magnetization produced by the poles in this example is a skewed magnetization.

In operation, the windings 126 of the stator 100B receive control signal from the PCB assembly 100C and electromagnetically interact with the bonded magnet 104 of the rotor 100A. Through the electromagnetic interaction between the poles on the magnet 104 and the stator windings 126, the bonded magnet 104 is driven into rotation. The shaft 108, which connects with the bonded magnet 104 through the end cap 106, and is supported by the bearings 114, 140, is thus driven into rotation for driving a load operably connected to the shaft 108.

The motor in the present embodiment is relatively light and compact. It can provide high torque and can operate efficiently, with high power density and torque density. The motor can be manufactured easily and at low cost. The use of bonded magnet allows the magnetic properties of the rotor to be tailored for specific applications. The mounting of the bonded magnet around a rotor yoke facilitates manufacture and assembly, and can provide higher magnetic flux and improved inertial effect. Alternatively, the rotor yoke can be mounted around the bonded magnet to improve flux linkage. The motor end cap, as part of the motor, can provide effective cooling, thereby effectively preventing overheating during operation.

For simplicity and clarity, the detailed winding scheme and control of the stator windings are not illustrated. Also, the drawings present the motor schematically and not necessarily in scale. It will be appreciated by persons skilled in the art that numerous variations and modifications may be made to the described embodiments, and that the described embodiments should be considered in all respects as illustrative, not restrictive.

For example, the stator may have a different form. The stator may have more than ten teeth or less than ten teeth (but at least two). The teeth need not have identical form and dimension, but can have different width and height. For example, adjacent teeth can be of different width. The separation between adjacent teeth can alter such that the teeth do not distribute evenly angularly. The tips of the teeth can be different thickness. Their radial outer surfaces preferably define a smoothly shaped contour (e.g., annular). The windings wounded onto the teeth can be arranged in with one or more groups each under a respective control signal. The number of wires for the windings may be selected for specific application.

The rotor may have a different form. The position of the rotor yoke and the bonded magnet can be exchanged. The bonded magnet can be of other shape, and may have more than or less than ten poles (at least two, even numbered). The arc segments of the poles may be of different size. The poles may be skewed. The bonded magnet may be arranged around (on the outer surface) of the rotor yoke or vice versa. The end cap may take a different form. The end cap attached to the bonded magnet or the rotor yoke can have no heat dissipation means, or alternative or additional heat dissipation means. For example, the radial vanes can be replaced with fan blades. The end cap may have any number of vanes, blades, etc. The end cap may incorporate a fan. The motor shaft can take different form, with additional or no stepped portion. The motor shaft can take any cross-sectional shape. The axial end of the shaft need not be threaded. The motor shaft can rotate on any types of bearing, such as ball bearing, roller bearing, etc. The motor shaft can be considered as part of the rotor or alternatively as a separate part. The integrated PCB assembly can be considered as part of the stator, or alternatively, as a separate part.

The PCB assembly may be shaped differently. The PCB assembly may have more than four or less than four mounting portions. The mounting portions need not be arranged oppositely. The mounting portions can be a hole of any shape, optionally threaded, for receiving a fastener such as screw, nut, bolt, etc. Alternatively, the mounting portions can be a fastener, such as a projection, a latch, etc., arranged to engage with holes on another structure.

The dimensions of the motor may vary. The air gap G1 is preferably less than 1.50 mm thick, more preferably less than 1.00 mm thick. The thickness of the magnet is preferably between 1.00 mm and 8.00 mm. The rotor yoke is preferably thicker than the magnet, but in some cases it may be thinner.

The outer rotor motor of the invention can be used in power tools such as drills, drivers, etc., gardening tools such as mowers, chainsaws, blowers, trimmers, etc., and various indoors/outdoors electrical appliances such as fan, ceiling fan, food processor, blender, juicer, vacuum cleaner, dishwashers, washing machines, etc. The outer rotor motor can operate with different power, preferably DC power. In one example, the DC power is provided by one or more battery pack(s) with nominal voltage of 18V, 36V, 48V, 56V, etc.

1. An outer rotor motor, comprising:
a stator; and
a rotor including:
a bonded magnet arranged around the stator, with an air-gap arranged between the bonded magnet and the stator;
a rotor yoke arranged around the bonded magnet; and
an end cap including vanes and connected with the rotor yoke.

2. The outer rotor motor of claim 1, wherein the bonded magnet is in the form of a hollow cylinder.

3. The outer rotor motor of claim 2, wherein the bonded magnet has circumferentially alternating poles.

4. The outer rotor motor of claim 3, wherein the poles are of substantially the same angular extension.

5. (canceled)

6. The outer rotor motor of claim 1, further comprising an integrated PCB assembly arranged on one side of the bonded magnet opposite the end cap.

7. The outer rotor motor of claim 6, wherein the integrated PCB assembly includes mounting portions for mounting the outer rotor motor to a support structure.

8. The outer rotor motor of claim 6, wherein an axial gap is defined between the bonded magnet and the integrated PCB assembly.

9. (canceled)

10. The outer rotor motor of claim 1, wherein the vanes extend radially and are evenly angularly spaced apart.

11. The outer rotor motor of claim 10, wherein an air flow opening is arranged between respective adjacent vanes.

12. The outer rotor motor of claim 1, further comprising an integrated PCB assembly arranged on one side of the bonded magnet opposite the end cap;
wherein an axial gap is defined between the bonded magnet and the integrated PCB assembly;
wherein an air flow opening is arranged between respective adjacent radially-extending vanes; and
wherein the air-gap, the axial gap, and the air flow openings are in fluid communication to define a cooling air flow path.

13. The outer rotor motor of claim 1, wherein the rotor further comprises a shaft operably coupled with bonded magnet for rotation, wherein the shaft extends through the end cap, the bonded magnet, the stator, and the PCB assembly.

14. The outer rotor motor of any one of claim 1, wherein the outer rotor motor is a DC brushless motor.

15. A rotor for an outer rotor motor, comprising:
a bonded magnet configured to be arranged around a stator and spaced apart from the stator, with an air-gap arranged between the bonded magnet and the stator,
a rotor yoke arranged around the bonded magnet; and
an end cap including vanes and connected with the rotor yoke.

16. The rotor of claim 15, wherein the bonded magnet is in the form of a hollow cylinder.

17. The rotor of claim 16, wherein the bonded magnet has circumferentially alternating poles.

18. The rotor of claim 17, wherein the poles are of substantially the same angular extension.

19. (canceled)

20. (canceled)

21. The rotor of claim 15, wherein the vanes extend radially and are evenly angularly spaced apart.

22. The rotor of claim 21, wherein an air flow opening is arranged between respective adjacent vanes.

23. An outer rotor motor comprising the rotor of claim 15.

24. An electric appliance or tool comprising the outer rotor motor of claim 23.

25. The outer rotor motor of claim 1, wherein an axial end of the end cap facing the bonded magnet includes a cutout for receiving part of the bonded magnet such that the end cap and the bonded magnet together define a smooth circumferential outer surface.

25. The outer rotor motor of claim 1, wherein the rotor yoke is electromagnetically conductive.
